(19) United States
(12) Patent Application Publication
(10) Pub. No.: US 2018/0039096 A1
(43) Pub. Date: Feb. 8, 2018

(54) ACCOMMODATION ASSISTING LENS

(71) Applicant: JINS INC., Maebashi-Shi (JP)

(72) Inventors: Shunsuke Shioya, Maebashi-Shi (JP); Kazuyoshi Itou, Kawanishi-shi (JP); Takanori Nomura, Wakayama-shi (JP)

(21) Appl. No.: 15/544,740

(22) PCT Filed: Feb. 2, 2016
(86) PCT No.: PCT/JP2016/053110

§ 371 Date: Jul. 19, 2017

(30) Foreign Application Priority Data
Feb. 3, 2015 (JP) 2015-019661

(51) Int. Cl. G02C 7/02; G02B 1/14; G02B 1/115; G02C 7/10; G02C 7/04

(52) U.S. Cl. CPC G02C 7/022; G02C 7/104; G02C 7/049; G02B 1/115; G02B 1/14; G02C 2202/06; G02C 2202/10

(57) ABSTRACT

An accommodation assisting lens comprises a lens main body, and dots that are isotropically and uniformly disposed in the lens main body, and in a visible light region, a difference in average transmittance between a dot portion based on the dots, and a non-dot portion other than the dot portion is 2% to 50% inclusive.

### TECHNICAL FIELD

The present invention relates to an accommodation assisting lens.

### BACKGROUND ART

Conventionally, there have been known eyeglasses that automatically adjust focuses. For example, there are eyeglasses each including means that detects a distance up to a position where both eyes are fixed, a lens capable of adjusting a focal distance, and means that adjusts a focal distance of a lens system based on distance information that is detected (refer to Patent Literature 1, for example).

### CITATION LIST

### Patent Literature

Patent Literature 1: Japanese Patent Laid-Open No. 2000-249902

### SUMMARY OF INVENTION

### Technical Problem

However, the eyeglasses described in Patent Literature 1 each need a plurality of components such as a visual line direction detector for detecting a distance, and a device that changes the focal distance of the lens. Therefore, a structure of the eyeglasses is very complicated.

Thus, the present invention has an object to provide a lens that can assist accommodation with a simple structure.

### Solution to Problem

An accommodation assisting lens in one aspect of the present invention comprises a lens main body, and dots that are isotropically and uniformly disposed in the lens main body, wherein in a visible light region, a difference in average transmittance between a dot portion based on the dots, and a non-dot portion other than the dot portion is 2% to 50% inclusive.

### Advantageous Effects of Invention

According to the present invention, it is possible to assist accommodation with a simple structure.

### BRIEF DESCRIPTION OF THE DRAWINGS

FIG. 1 shows an example of a result of a verification experiment of an accommodation response time.

FIG. 2 shows an example of a model of an optical simulation.

FIG. 3 shows an example of a dotted structure provided on a lens surface.

FIG. 4 shows an example of a relationship between contrast and a defocus amount in each phase difference.

FIG. 5 shows an example of a relationship between a defocus amount and blur.

FIG. 6 is a diagram for explaining an influence that is given to visibility by a defocus amount and a phase difference.

FIG. 7 shows an example of a relationship between contrast and a defocus amount in each light-shielding rate.

FIG. 8 shows a section of a part of a black and gray striped image.

FIG. 9 shows an example of a spectrum intensity in the section shown in FIG. 8.

FIG. 10 is a view for explaining visibility by reduction in contrast.

FIG. 11 shows a result of experiment A.

FIG. 12 shows a result of experiment B.

FIG. 13 is a diagram for explaining a relationship between a design parameter in a lens and contrast.

FIG. 14 shows a relationship between a wavelength and a reflectance in a lens A.

FIG. 15 shows a relationship between a wavelength and a reflectance in a lens B.

FIG. 16 shows a relationship between a wavelength and a reflectance in a lens C.

FIG. 17 shows an experimental result concerning accommodation and near vision using the lenses A to C.

FIG. 18 is a diagram for explaining an example of the lens A.

FIG. 19 is a view for explaining consideration based on experiment 2.

FIG. 20 is a front view showing an example of eyeglasses in example 1.

FIG. 21 is a side view showing the example of the eyeglasses in example 1.

FIG. 22 is a view showing an example of an end surface along line A-A of a lens at a time of wearing the eyeglasses in example 1.

FIG. 23 is a view showing an example of a contact lens in a second example.

FIG. 24 is a view showing an example of a scope optical system in a third example.

### DESCRIPTION OF EMBODIMENT

Hereunder, embodiments of the present invention will be described with reference to the drawings. The embodiment described as follows is only for illustration, and does not intend to exclude application of various modifications and techniques that are not explicitly shown below. That is, the present invention can be carried out by being variously modified within a range without departing from the gist of the present invention. Further, in the following illustrations of the drawings, the same or similar parts are expressed by being assigned with the same or similar reference signs. The drawings are schematic, and do not always correspond to actual sizes, ratios and the like. Among the drawings, parts differing in size relation and ratio from one another may be included.

### Embodiment

Before explaining a lens according to the present invention, the circumstances leading up to inventing the lens according to the present invention and so on will be explained. The inventors have found that by providing a difference in phase in a first portion and a second portion in a lens, and providing a difference in transmittance, focus is easily achieved, and near vision is improved. First of all, experiments and the like leading up to the finding will be described. To begin with, a first experiment includes a plurality of experiments that were conducted for verifying a first hypothesis by the inventors who realized that if a subject wears a lens in which a geometric structure of a micrometer order is arranged on a surface, the subject easily obtains focus (referred to as the first hypothesis). Hereunder, the lens is referred to as a first lens. Further, a second experiment is an experiment that was conducted to verify a second hypothesis by the inventors who realized that when a subject wears a lens having a difference in transmittance between a dot portion and a non-dot portion which are provided in the lens, near vision of the subject is easily improved (referred to as the second hypothesis). First, the first experiment will be described.

### <Verification Experiment on Accommodation Response Time>

Accommodation response time (ART: Accommodation Response Time) at a time of seeing through the first lens is verified by using an accommodopolyrecorder. In this experiment, as the first lens, a lens having a surface of a honeycomb structure is used. ART refers to a time period until an eye focuses on an indicator when the indicator is repeatedly moved to a near point, a far point, the near point, the far point, etc. The accommodopolyrecorder is a device that diagnoses a function of focusing, based on lengths of the time period until an eye focuses on the indicators that are placed far and near.

In this experiment, measurement is performed with dominant eyes of 11 subjects, ART at a time of the indicator moving from a near point to a far point (hereunder, also referred to as ART relaxation), and ART at a time of the indicator moving from the far point to the near point (hereunder, also referred to as ART tension) are measured by using a lens having a honeycomb structure (a lens with a surface of a honeycomb structure) and a lens having no honeycomb structure (an ordinary spherical lens).

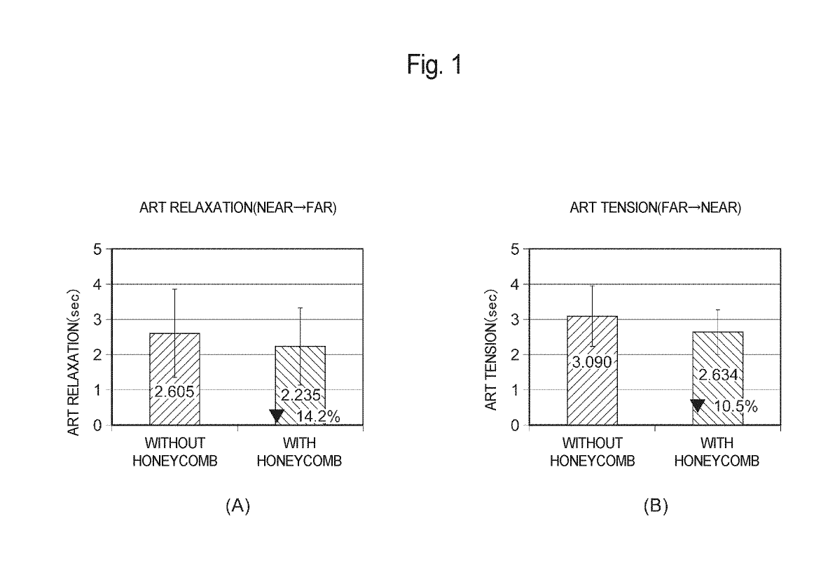

FIG. 1 shows an example of a result of the verification experiment of the accommodation response time. FIG. 1 (A) shows an example of an experimental result of ART relaxation. As shown in FIG. 1 (A), in ART relaxation, ART of a subject wearing the lens having a honeycomb structure can be made shorter by approximately 14.2% than ART of a subject wearing the lens having no honeycomb structure.

FIG. 1 (B) shows an example of an experimental result of ART tension. As shown in FIG. 1 (B), in ART tension, ART of the subject wearing the lens having a honeycomb structure can be made shorter by approximately 10.5% than ART of the subject wearing the lens having no honeycomb structure. From the result shown in FIG. 1, the lens having the honeycomb structure can be said as easily focusing.

### <Optical Simulation>

Next, an optical simulation will be described, which was conducted by using a lens in which microdots are arranged periodically as the first lens, in order to find a reason why focusing is easily obtained by wearing the first lens.

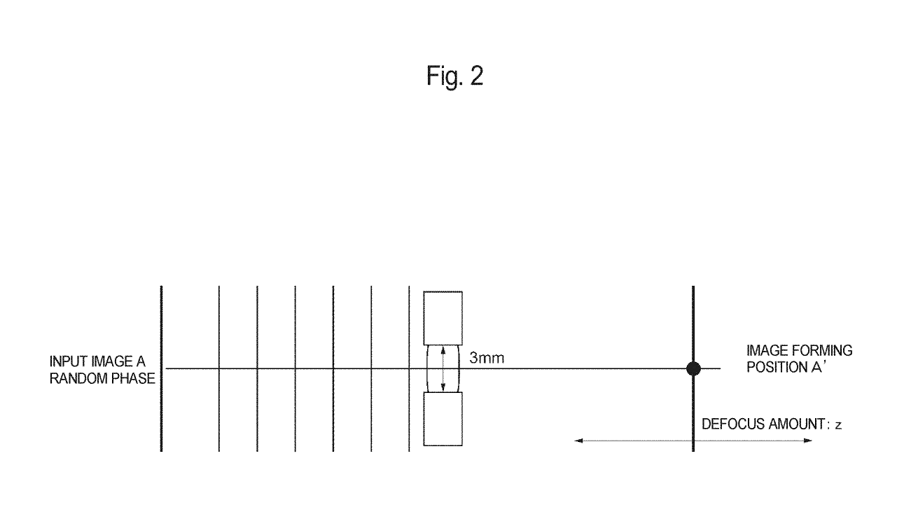

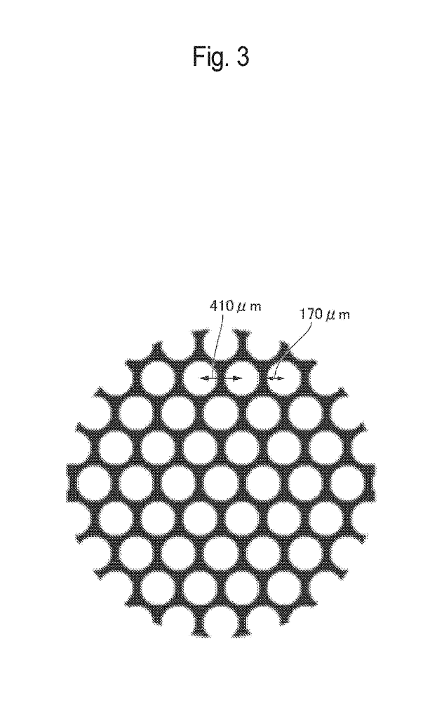

FIG. 2 shows an example of a model of the optical simulation. The model illustrated in FIG. 2 uses a point light source of 10 μm as a light source, and uses a lens of an aperture diameter of 3 mm. In the lens, 3 mm represents an average pupil diameter, and as shown in FIG. 3, the lens surface has a structure obtained by simplifying the honeycomb structure to circles.

Further, a lens focus is 150 mm, and a focus position A′ is 300 mm from the lens. One pixel size of an input image is 10 μm. Further, as a wavelength (hereunder, also referred to as a reference wavelength) of the light source, 546 nm in a wavelength region to which eye sensitivity is said as high is used as an example.

FIG. 3 shows an example of a dotted structure provided on the lens surface. The structure shown in FIG. 3 is a simplified structure of a honeycomb structure, and a pitch of a circle is 410 μm, a radius of the circle is 170 μm, and transmittance of light is 100% to 50%. A white portion in the structure shown in FIG. 3 is a high-refractive region, and a black portion is a low-refractive region. Phase differences of the high-refractive region and the low-refractive region to the reference wavelength are varied between zero and π/2.

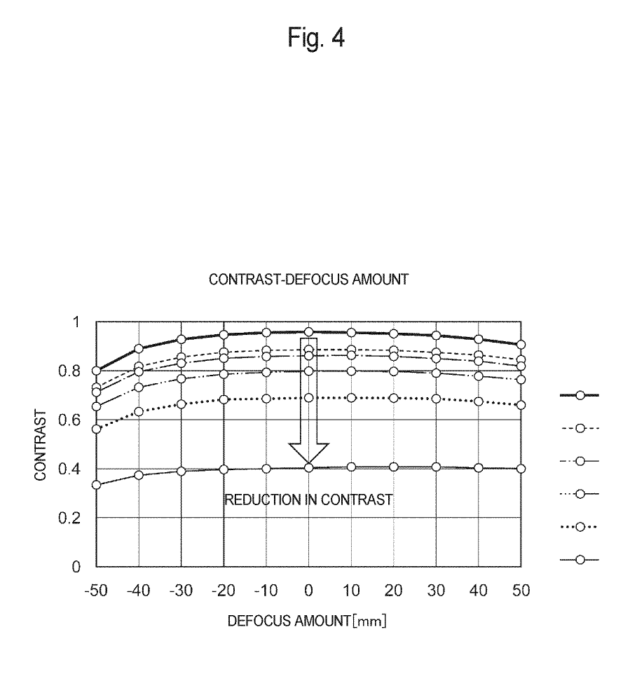

FIG. 4 shows an example of a relationship between contrast and a defocus amount in each phase difference. In the graph shown in FIG. 4, the contrast reduces as the phase difference to the reference wavelength becomes larger. Further, the defocus amount does not affect reduction in contrast so much.

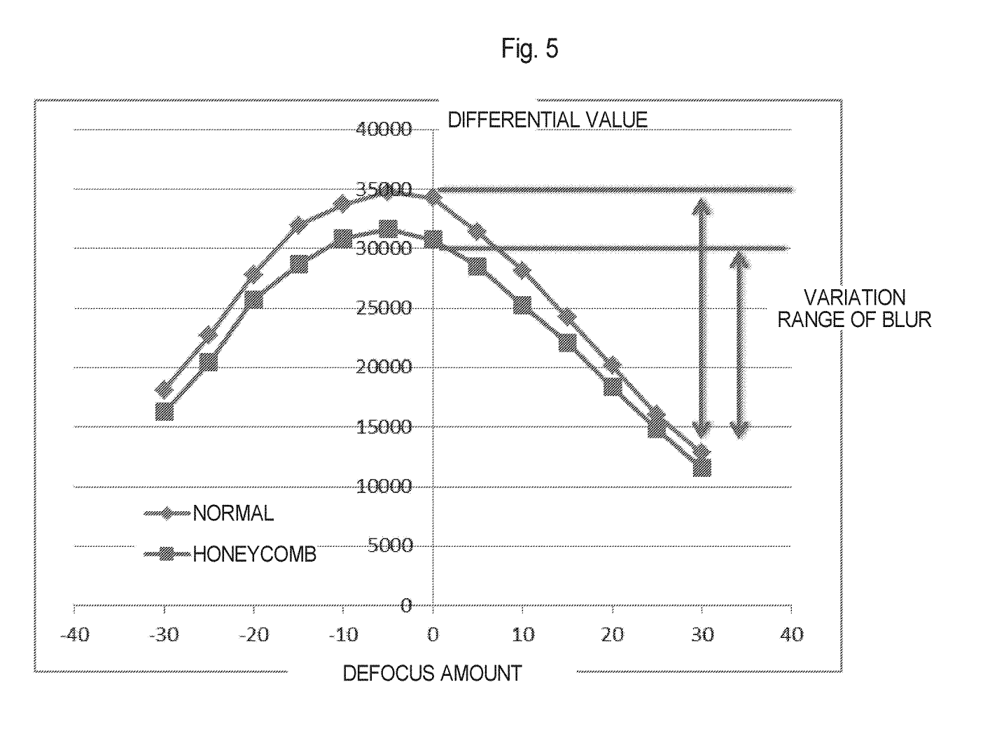

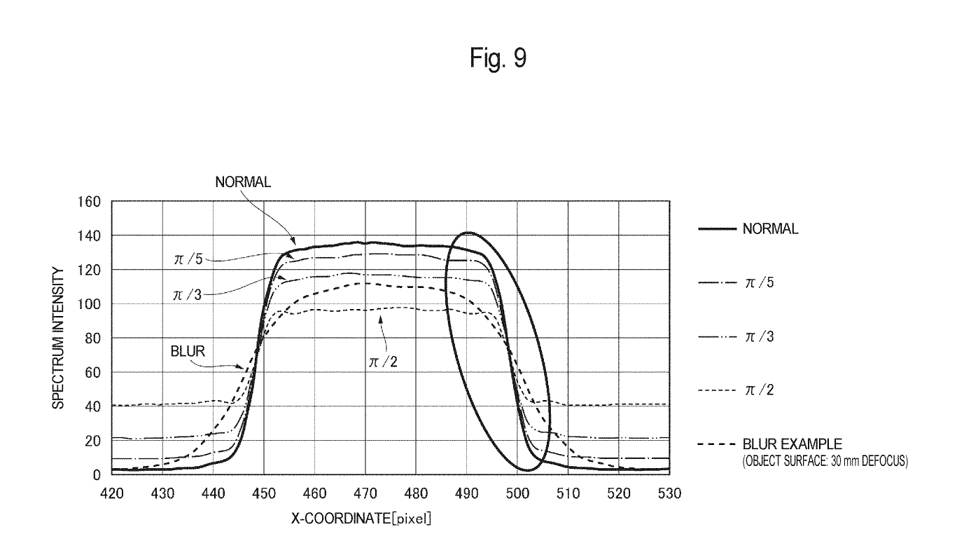

FIG. 5 shows an example of a relationship between the defocus amount and blur. The graph shown in FIG. 5 expresses a maximum value of a differential value of a line shown in a graph of FIG. 9 that will be described later, and a degree of blur. In the graph shown in FIG. 5, a lens having a honeycomb structure has a smaller decrease range of a differential value from focus to defocus than a normal lens. Therefore, the lens having the honeycomb structure can be said to have a smaller sense of defocusing because the lens having the honeycomb structure has a smaller variation range in blur at a time of defocusing than the normal lens.

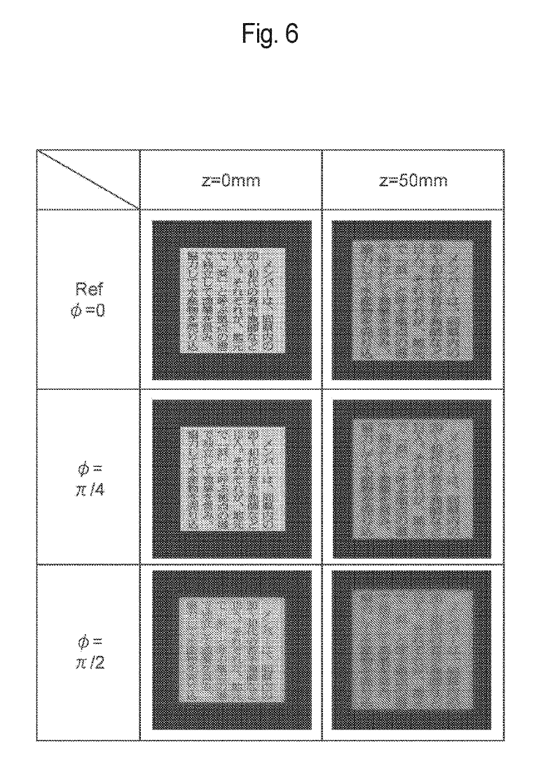

FIG. 6 is a diagram for explaining an influence that is given to visibility by the defocus amount and a phase difference. FIG. 6 shows images in the image forming position illustrated in FIG. 2 in the respective phase differences at a time of focus (z=0 mm), and at a time of defocus (z=50 mm). As shown in FIG. 6, at the time of focus, visibility of the image is hardly influenced when a phase difference φ to the reference wavelength=π/4, but when the phase difference φ=π/2, an image with poor visibility is obtained. Further, at the time of defocus, all of the images of the respective phase differences have unfavorable visibilities.

Here, although contrast is reduced by increasing the phase difference by using the dotted structure at the time of focus, visibility is not influenced so much if the phase difference is within a certain fixed range.

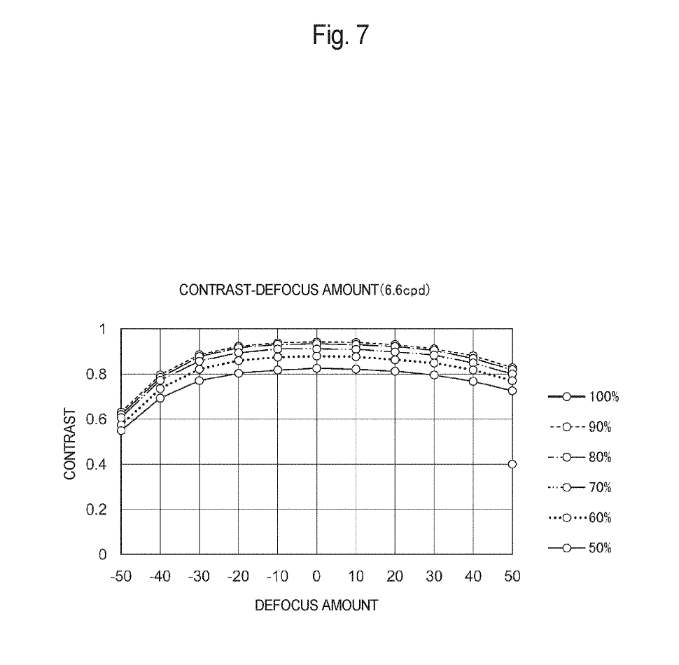

FIG. 7 shows an example of a relationship between contrast and a defocus amount in each light-shielding rate. In the graph shown in FIG. 7, it is found that the contrast is also reduced when the light-shielding rate is reduced. Therefore, it is effective to reduce not only the phase difference but also the light-shielding rate when reducing contrast. The first lens which is used in the graph shown in FIG. 7 is a lens in which microdots that reduce the light-shielding rate are arranged.

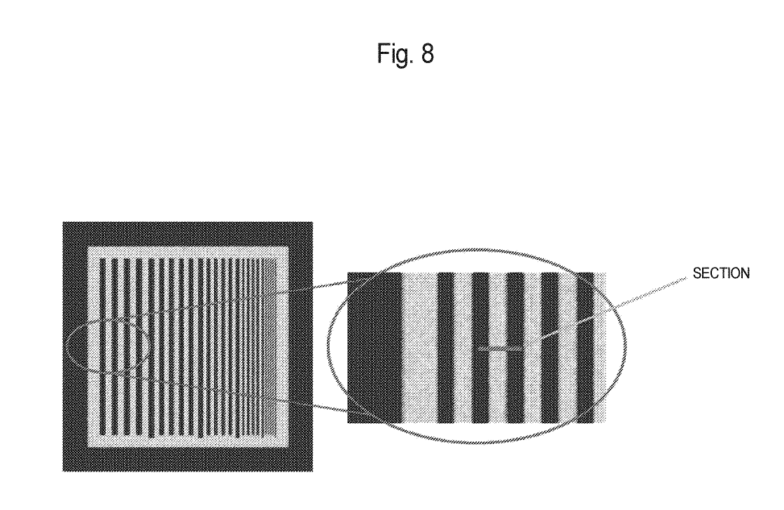

Next, it will be described that adding a phase difference to a lens does not cause blur of an image but reduces contrast. FIG. 8 shows a section of a part of a black and gray striped image. In the section of a right enlarged view shown in FIG. 8, spectrum intensities in respective boundaries of a black color, a gray color and the black color from the left are calculated, and difference in brightness in the section is examined.

Specifically, in the section shown in FIG. 8, differences in brightness in the section on which images are formed at the time of focus are examined, by the respective lenses that differ in phase difference in the model illustrated in FIG. 2. FIG. 9 shows examples of the spectrum intensity in the section shown in FIG. 8, in the respective lenses. As shown in FIG. 9, in each of the lenses, the spectrum intensity becomes strong (brightness becomes high) in the gray color portion, and the spectrum intensity becomes weak (brightness becomes low) in the black color portion. Further, according to the graph shown in FIG. 9, it is found that a brightness difference between the black color portion and the gray color portion becomes smaller as the phase difference becomes larger, and contrast is reduced.

Further, FIG. 9 shows the spectrum intensity in the blurred section at the time of the defocus amount of 30 mm, for reference. Seeing respective inclinations in a region AR102, the inclinations are steep and constant irrespective of variations in the phase difference, and do not become gentle as that of the blurred section. Therefore, it is found that increasing the phase difference reduces contrast without causing blur.

Summarizing the above described experiment, in the first lens, light is diffracted as a result that the phase difference occurs to the light (the reference wavelength, for example) passing through the lens, and reduces the contrast. Further, as the phase difference becomes larger, contrast is reduced. Reducing contrast does not cause blur, but can affect visibility. In particular, when contrast is reduced in a predetermined range, visibility is not affected, but when the contrast is reduced to exceed the predetermined range, visibility is worsened. It is because of a diffraction phenomenon of light that contrast is also reduced by shielding the lens from light.

Here, as a result of the above described experiment, the inventors have reached a new hypothesis that in the first lens, focus is easily obtained, by contrast being reduced while no blur occurs.

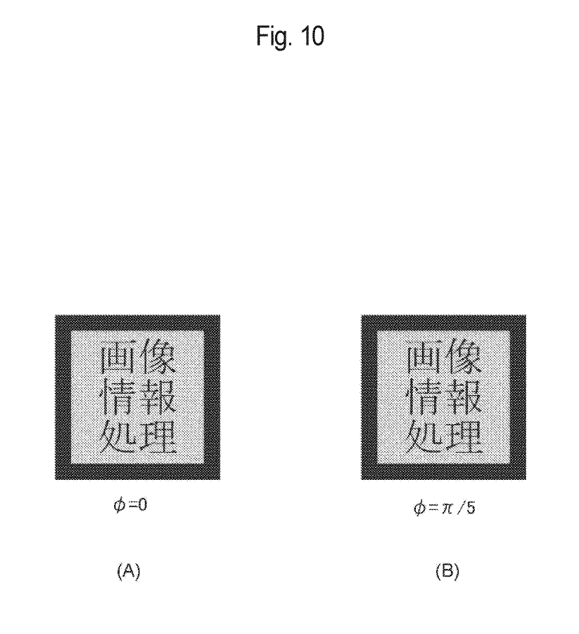

FIG. 10 is a diagram for explaining visibility by reduction in contrast. FIG. 10 (A) shows an image in the image forming position with a phase difference φ=0 to the reference wavelength, in the experiment illustrated in FIG. 2. FIG. 10 (B) shows an image in the image forming position of the phase difference φ=π/5 to the reference wavelength.

Comparing both the images shown in FIGS. 10 (A) and (B), both images do not differ so much in visibility. According to FIG. 4, with φ=π/5, visibility is not reduced so much, although contrast is reduced by approximately 10% at the time of focus.

From the above, the inventors conducted an experiment to verify a new first hypothesis that reduction in contrast makes focus easier.

### <First Hypothesis Verification Experiment>

Experiment contents are as follows.

### (Experiment A)

A time (ART) required for focusing on each test image displayed on a monitor of PC (Personal Computer) from a state where a subject closes his or her eyes and is relaxed (approximately five seconds) is measured. It is approximately 40 cm from the subject to the monitor. Contrasts of the respective test images are set at 100%, 95%, 90%, 85% and 80% by using a function of the monitor, for example.

Number of measurements: 20 times for the test image of each of the contrasts

Measurement order: random

Subject: four persons

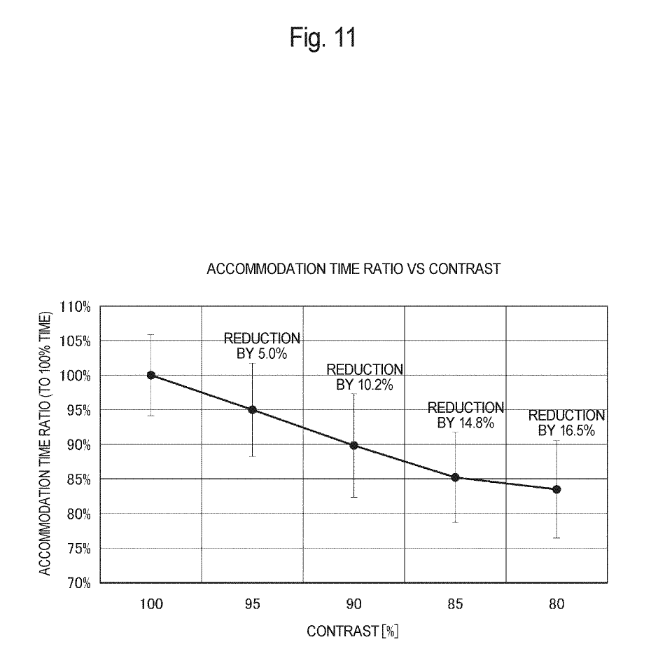

FIG. 11 shows a result of experiment A. As shown in FIG. 11, percentage of an average ART of the test image of each of the contrasts is graphed by setting the average ART of the test image with the contrast of 100% to 100%.

In the example shown in FIG. 11, the average ART is shortened at a constant ratio up to the test image of the contrast of 85%. Specifically, as the contrast is reduced by 5%, the average ART is reduced by approximately 5%. However, reduction in the average ART from the test image with the contrast of 85% to the test image of the contrast of 80% is 1.7%. That is, it is conceivable that even when the contrast is reduced to 85% or less, a reduction rate of the average ART converges.

### (Experiment B)

Experiment conditions are similar to those in experiment A, and what is different is that in the test image with the contrast of 100%, the first lens shown in FIG. 3 is worn as the eyeglass lens, and ART is measured.

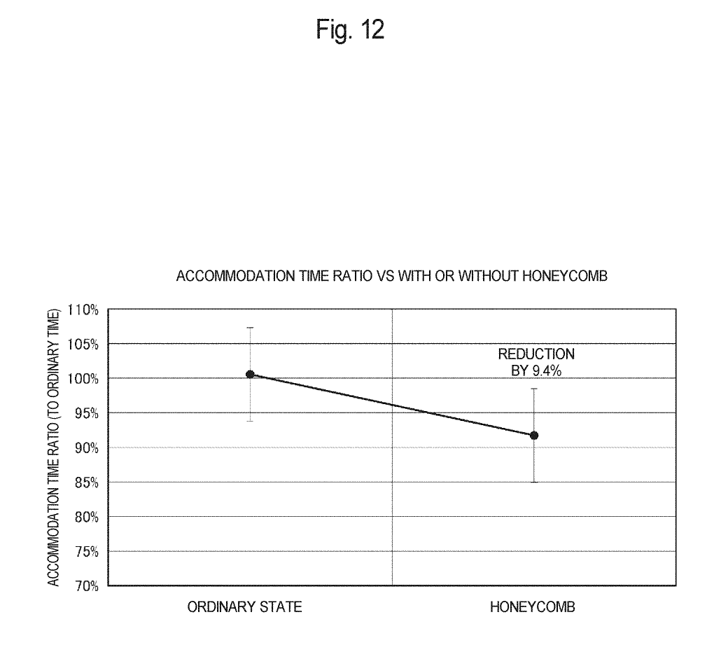

FIG. 12 shows a result of experiment B. As shown in FIG. 12, wearing the first lens reduces ART in the test image with the same contrast of 100%. That is, it can be said that ART can be reduced by reducing the contrast by the first lens.

Consequently, it is found that reduction in contrast is effective in reduction of ART by experiment A, and further, by experiment B, it is found that even when the lens that reduces contrast is worn, ART can be reduced similarly.

Here, when the lens that reduces contrast is worn as eyeglasses to assist accommodation, visibility by reduction in contrast becomes a problem. Therefore, how far the contrast can be reduced is considered from the viewpoint of visibility. Considering by using reduction in phase difference which is correlated with reduction in contrast, there is no problem in visibility when the phase difference is up to around π/4, according to FIG. 6. According to FIG. 4, the contrast is approximately 80% when the phase difference is π/4.

Consequently, comparing and carefully considering reduction of ART by reduction in contrast and securement of visibility, it is preferable to reduce the contrast from 100% to approximately 80%, that is, when it is converted into the phase difference φ to the reference wavelength, the phase difference φ preferably has a value in a range of 0<φ≦approximately π/4.

Further, when attention is paid to ART, for example, according to FIG. 11, the reduction rate of the average ART does not change so much even when the contrast increases from 80% to 85%, but when the contrast is increased to 85% or more, the reduction rate of the average ART changes to approximately 90% from approximately 85%. The smaller reduction rate represents the shorter average ART. When the contrast is 85%, the phase difference φ corresponding to the contrast is π/5. Accordingly, from the viewpoint of ART and visibility, it is more preferable to set the phase difference φ at a value in a range of π/5<φ≦π/4.

### <Lens Design>

In order to make focus easy, the lens that reduces contrast is considered. It is also possible to reduce contrast by reducing the light-shielding rate as shown in FIG. 7, but in this case, it is considered to reduce contrast while ensuring visibility by providing a phase difference in the light passing through the lens (the reference wavelength, for example).

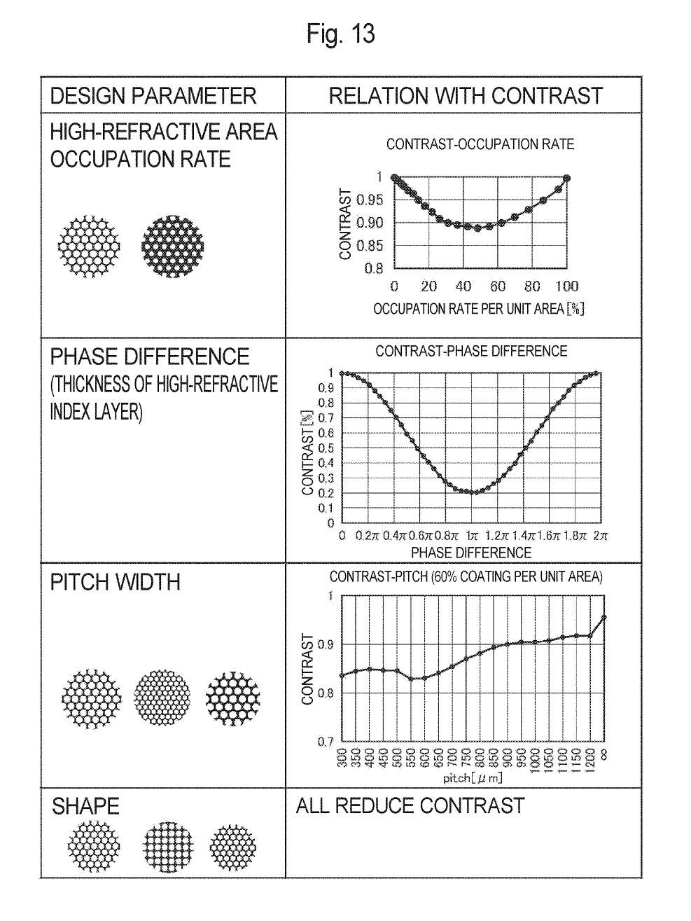

FIG. 13 is a diagram for explaining relationships of design parameters in a lens with contrast. In an example shown in FIG. 13, as examples of design parameters of the lens, an occupation rate of a high-refractive area (white dotted area), the phase difference (film thickness of a high-refractive layer), a pitch width, and a shape are included. Further, examples of pattern structures corresponding to the design parameters are illustrated in the design parameters.

When the occupation rate of the high-refractive area is reduced to 0% from 100%, the contrast is reduced the most when the occupation rate is approximately 50%. Therefore, when the occupation rate is set at approximately 50%, the contrast can be reduced, and a film thickness of the high-refractive area can be reduced. Considering lens production, lens production is easier by changing the occupation rate than changing the film thickness, so that it is preferable to reduce contrast as much as possible by using the occupation rate, by setting the occupation rate at approximately 40% to 60% inclusive.

Next, the phase difference to the reference wavelength is set as one example of the design parameter of the lens. The relationship of the phase difference and the contrast shown in FIG. 13 is a graph at a time of the contrast with the phase difference φ=0 being normalized to 1, and is slightly different from the relationship of the actual measurement values shown in FIG. 4. At the time of actual lens design, either the relationship shown in FIG. 4 or the relationship shown in FIG. 13 may be used, or the lens may be designed by using an equation approximating the relationship between the contrast and the phase difference. In the example shown in FIG. 13, the contrast can be reduced to a value of 80% to approximately 85%, when visibility is taken into consideration.

Next, in the pitch width, the number of coatings entering the pupil diameter of 3 mm is decreased when the pitch width becomes large. Consequently, in order to reduce contrast while preventing decrease in the number of coatings, the pitch width of 300 to 500 μm is suitable.

In the end, in the shape of the dot to be a convex portion, the shape or the like is changed. For example, disposition of circles is changed, the circle is changed to a honeycomb shape, a triangular shape, and a quadrangular shape. It is confirmed that the shapes and dispositions of the convex portions are all effective to reduce contrast by an experiment. Concave portions may be in dot shapes.

The above described lens design is only an example, and any lens having a mechanism that reduces contrast to assist accommodation is included in the present invention.

Next, the aforementioned second experiment will be described. The inventors have found an effect that near vision is improved, besides the effect of making focus easy, when the subjects wear the aforementioned first lens. Here, the inventors pay attention to a pinhole effect that is well known as an improvement in near vision, and further pay attention to a difference in light transmittance between the dot portion corresponding to a pinhole and the non-dot portion that is not a dot. Thus, in order to investigate an influence by the difference in transmittance between the dot portion and the non-dot portion, the inventors conducted the second experiment. Hereunder, the second experiment will be described.

### <Influence by Difference in Transmittance>

In the second experiment, three lenses each having a difference in average transmittance in a visible light region (for example, 380 nm to 780 nm) in the dot portion and the non-dot portion are used.

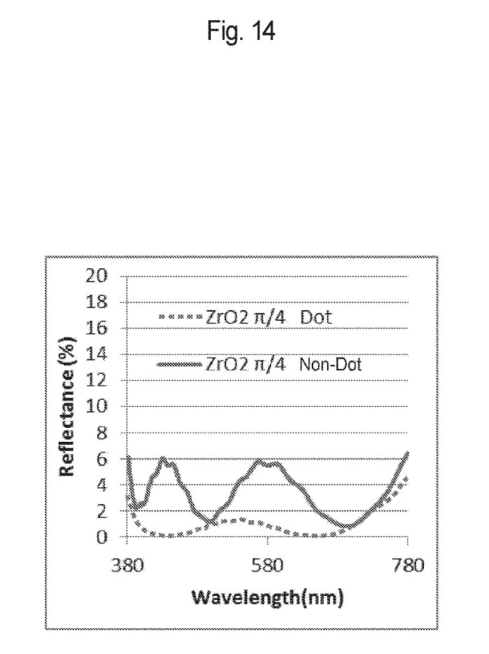

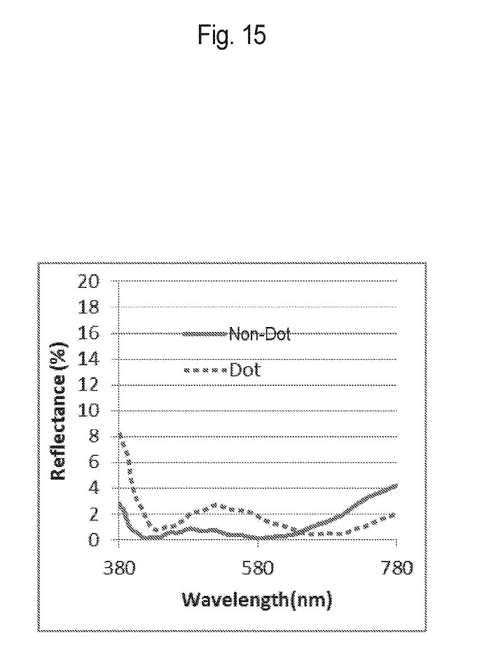

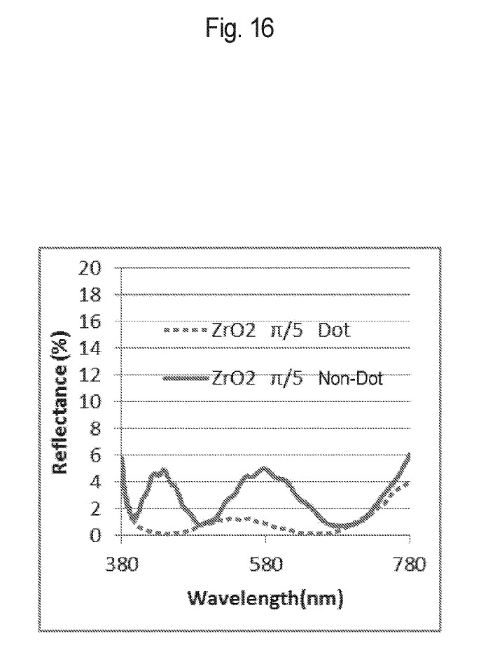

FIG. 14 shows a relationship between a wavelength and a reflectance in a lens A. FIG. 15 shows a relationship between a wavelength and a reflectance in a lens B. FIG. 16 shows a relationship between a wavelength and a reflectance in a lens C. The examples shown in FIGS. 14 to 16 each use reflectance, but may use transmittance. The transmittance is calculated based on transmittance=1−reflectance. Hereunder, transmittance will be described as an example.

The lens A shown in FIG. 14 is a newly developed lens, uses a zirconium dioxide (zirconia, chemical formula: ZrO₂) as a material, and is designed so that a phase difference of the reference wavelengths transmitted through the dot portion and the non-dot portion is π/4. Further, in the lens A, in a visible light region, a difference in average transmittance between the dot portion and the non-dot portion is set as 2.4%. An average transmittance t_ave is calculated based on the following expression (1).

$$\begin{matrix}[ Expression 1 ] & \\ t\_ave = \frac{{\int }_{380}^{780} t ( λ ) d λ }{( 780 - 380 ) \times 100 ( \% )} \times 100 \\ t ( λ ) \text{:} transmittance ( \% ) & ( 1 )\end{matrix}$$

Further, in the lens A, a difference in average transmittance in a predetermined region (around 400 nm and around 580 nm) in a visible light region is larger than a difference in average transmittance in a region other than the predetermined region in the visible light region. Speaking from another viewpoint, in the lens A, a difference in transmittance at a peak time between the dot portion and the non-dot portion in the predetermined region (around 400 nm and around 580 nm) is 4% or more. Basically, the transmittance is high in the dot portion, and the transmittance is low in the non-dot portion.

Further, light is transmitted in the dot portion, and light is reflected in the non-dot portion, whereby the pinhole effect by the dot portion can be produced. Thereby, depth of focus is extended, so that a blurred portion can be clearly seen. The predetermined region in the visible light region can include at least a blue wavelength region. Thereby, eye fatigue can be suppressed by cut of blue light while the pinhole effect is produced.

The lens B shown in FIG. 15 is a lens that is already on the market, and has a pattern of a microscopic honeycomb structure. In the lens B, a difference in average transmittance between a honeycomb portion and a non-honeycomb portion is 0.5 in a visible light region.

The lens C shown in FIG. 16 is a lens that is developed for being compared with the lens A shown in FIG. 14, uses a zirconium dioxide as a material, and is designed so that a phase difference of reference wavelengths transmitted through a dot portion and a non-dot portion is π/5. Further, in the lens C, in a visible light region, a difference in average transmittance between the dot portion and the non-dot portion is set as 1.8%.

Further, in the lens C, differences in average transmittance in predetermined regions (around 400 nm and around 580 nm) in the visible light region are larger than differences in average transmittance in other regions than the predetermined regions in the visible light region. From another viewpoint, in the lens C, the differences in transmittance at a peak time between the dot portion and the non-dot portion in the predetermined regions (around 400 nm and around 580 nm) are 4% or more.

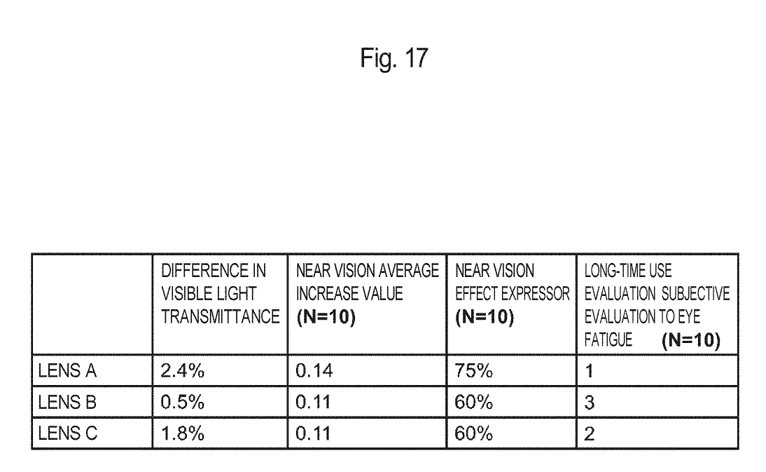

FIG. 17 shows an experiment result concerning accommodation and near vision using the lenses A to C. In an experiment shown in FIG. 17, 10 subjects of men and women of ages of 20 to 50 wore the respective lenses A to C, and an experiment on near vision was conducted in each of the lenses.

A near vision average increase value shown in FIG. 17 shows how much the near vision increased in average in the case where the subjects wore the respective lenses as compared with the case where the subjects did not wear the respective lenses. In the lens A, near vision increases by 0.14, whereas in the lenses B and C, near vision increases by 0.11.

A near vision effect expressor shown in FIG. 17 represents a ratio of persons who improved in near vision in the subjects. With the lens A, 75% of the subjects improved in near vision, whereas with the lenses B and C, 60% of the subjects improved in near vision.

According to the near vision average increase value and the near vision effect expressor shown in FIG. 17, it is found that the lens A is more effective in improvement in near vision than the lenses B and C. Further, when the lens A and the lens C are compared, a large difference lies in the differences in average transmittance between the dot portions and the non-dot portions in visible light, and it is considered that by the difference, the influences given to improvement in near vision differ. Thus, by the average transmittances of the lens A and lens C, a threshold value of the average transmittance which has an influence on improvement in near vision is considered to be at approximately 2.0%. Accordingly, it can be said that when the difference in average transmittance is less than 2.0, near vision is not improved so much, whereas when the difference in average transmittance is 2.0% or more, near vision is improved greatly.

Further, when patterning was applied so that a Cr metal forms the non-dot portion, the pattern shape of the dots can be visually observed when the difference in average transmittance between the dot portion and the non-dot portion exceeds 50%, and an adverse effect is exerted on visibility. Accordingly, the difference in average transmittance in the case where focus is easily obtained, the near vision is improved and visibility is not impaired is considered to be 2% to 50%.

A long-time use evaluation shown in FIG. 17 shows a subjective evaluation to eye fatigues of the subjects who worn the respective lenses for a long time. The subjects ranked each of the lenses in order that eyes of the subjects did not get tired. The result of ranking is the lens A for No. 1, the lens C for No. 2, and the lens B for No. 3. Consequently, the lens A also has an effect of hardly causing eye fatigue, as compared with the other lenses.

In the lens A shown in FIG. 17, an experiment on accommodation response time was conducted by using an accommodopolyrecorder. According to the experiment, it has been confirmed that when the subject wore the lens A, the accommodation response time was reduced by 8% in average as compared with the case where the subject did not wear the lens A.

### <Example of Lens A>

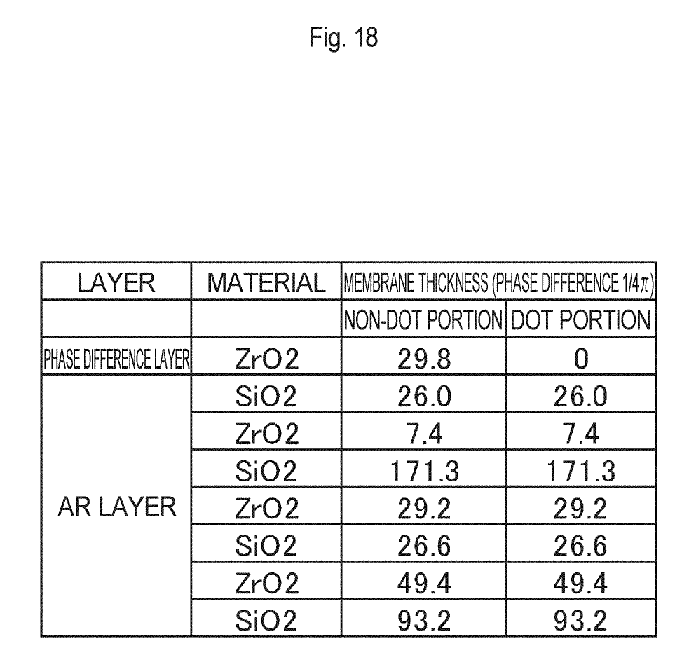

FIG. 18 is a diagram for explaining an example of the lens A. The lens A shown in FIG. 18 is supposed to be used as a lens for eyeglasses, for example. The lens A shown in FIG. 18 is formed with a film thickness of the non-dot portion of 29.8 nm so that the phase difference in the reference wavelength is π/4 with use of zirconia as a material of a phase difference layer.

Further, AR (Anti-Reflection) layers (also referred to as anti-reflection film patterns) are sequentially stacked on a hard coat layer of the base material in sequence from a top of a table shown in FIG. 18. For example, a silicon dioxide (chemical formula: SiO₂) of a film thickness of 26.0 nm is stacked on the hard coat layer, for example, and a zirconia of a film thickness of 7.4 nm is stacked thereon.

According to the AR layers shown in FIG. 18, the difference in average transmittance as shown in FIG. 14 can be produced. Further, the difference in average transmittance as shown in FIG. 14 may be produced by a pattern using a colored material such as a coloring matter and a metal, besides being produced by the difference in transmittance (reflectance) between the pattern portion and the non-pattern portion. For example, the difference in average transmittance may be produced by a coloring matter pattern provided on a lens surface.

As a coloring matter layer provided on the lens surface, in the case of dye, for example, there are cited Kayaset Blue 906 (made by Nippon Kayaku Co., Ltd.), Kayaset Brown 939 (made by Nippon Kayaku Co., Ltd.), Kayaset Red 130 (made by Nippon Kayaku Co., Ltd.), Kayalon Microester Red C-LS cone (made by Nippon Kayaku Co., Ltd.), Kayalon Mixroester Red AQ-LE (made by Nippon Kayaku Co., Ltd.), Kayalon Microester Red DX-LS (made by Nippon Kayaku Co., Ltd.), Dianix Blue AC-E (made by DyStar Japan Ltd.), Dianix Red AC-E01 (made by DyStar Japan Ltd.), Dianix Yellow AC-E new (made by DyStar Japan Ltd.), Kayalon Microester Yellow C-LS (made by Nippon Kayaku Co., Ltd.), Kayalon Microester Yellow AQ-LE (made by Nippon Kayaku Co., Ltd.), Kayalon Microester Blue C-LS cone (made by Nippon Kayaku Co., Ltd.), Kayalon Microester Blue AQ-LE (made by Nippon Kayaku Co., Ltd.), Kayalon Microester Blue DX-LS cone (made by Nippon Kayaku Co., Ltd.) and the like.

As the coloring matter layer, in the case of a pigment, for example, there are cited Quinacridone C1 122, Phthalocyanine C1 15, Isoindolinone C1 110, Inorganic C1 7, Phthalocyanine, Mono-azonaphthal AS, a carbon pigment and the like.

As the coloring matter layer, in the case of a metal, for example, there are cited a chrome, an aluminum, a gold, a silver and the like.

Further, the difference in average transmittance may be produced by combining the AR layers and a coloring matter pattern.

The lens A shown in FIG. 18 is used as an eyeglass lens, for example, whereby, a user wearing the eyeglasses easily obtains focus without impairing visibility, and improves in near vision. Further, the effect that eyes hardly get tired is also provided.

### <Consideration Based on Experiment 2>

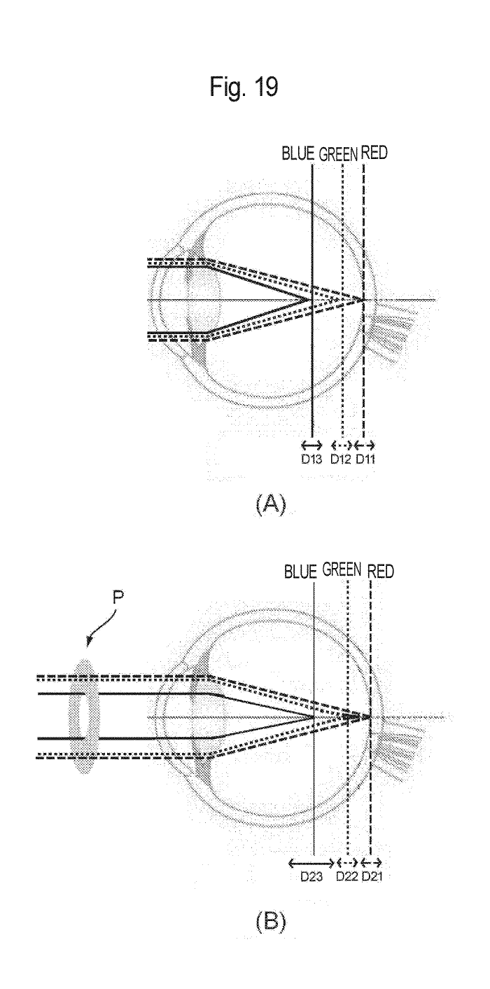

FIG. 19 is a diagram for explaining a consideration based on experiment 2. FIG. 19 (A) is a view showing a relationship among a focal point, a chromatic aberration, and a depth of focus of each of wavelengths using an ordinary colorless lens. A chromatic aberration refers to the fact that a focal distance forming an image on a retina differs depending on a light wavelength. As illustrated in FIG. 19 (A), when red focuses on a retina, green and blue focus on regions more frontward from the retina as the wavelengths become shorter as is the case of green and blue. Thereby, distances among focuses are long, a chromatic aberration occurs greatly, and blur occurs. In order to correct the chromatic aberration, focus is obtained by a brain performing image correction, and a ciliary muscle slightly moving, but the focusing exerts a burden on eyes. In FIG. 19 (A), D11 shows an example of the depth of focus of a red wavelength, D12 shows an example of the depth of focus of a green wavelength, and D13 shows an example of the depth of focus of a blue wavelength.

FIG. 19 (B) is a diagram showing a relationship among a focal point, a chromatic aberration, and a depth of focus of each of wavelengths using the lens A. The lens A can extend the depth of focus of the blue wavelength by the pinhole effect by the dot portion while cutting the blue wavelength. That is, the depth of focus of the blue wavelength extends to D23 from D13.

Here, a pinhole effect will be briefly described. As illustrated in FIG. 19 (B), by the lens A provided with a pattern P that produces a pinhole effect for the blue wavelength, light of the blue wavelength is narrowed to enter the eye. Thereupon, a range (depth of focus) of a surface where focusing is achieved extends, and a range that looks blurred in the state without the pinhole effect decreases. The depth of focus extending means that an angle formed by upper and lower light beams becomes small (acute). Further, since the depth of focus is extended, a muscle that adjusts the focus of the eye is not used excessively, so that an effect of relieving tension of the muscle of the eye is provided.

Further, as illustrated in FIG. 19 (B), by extending the depth of focus of the blue wavelength by the pinhole effect, a focusing position of the blue wavelength is increased, and the chromatic aberration is decreased. Therefore, focusing is easily obtained, and blur can be reduced. Accordingly, it can be said that by reduction (or the phase difference of the reference wavelength) in contrast by the doted pattern, and the difference in light transmittance between the dot portion and the non-dot portion, focus is easily obtained, and near vision is improved. The wavelength region in which the depth of focus is extended is not limited to the blue wavelength region, but the green and red wavelength regions are selectively cut by the lens A, and the amount of light that is incident on the eye may be reduced. Further, the lens A is caused to produce a pinhole effect by using the pattern of the dot portion, but the shape of the pattern is not limited to a dot, and may be a shape such as a honeycomb shape. Further, a pitch width between dots is allowed to be up to approximately 1500 μm when the pinhole effect is enhanced. Accordingly, when the example shown in FIG. 13 is taken into consideration, as the pitch width between the patterns such as dots, 300 to 1500 μm can be applied.

Hereunder, examples using lenses having parameters within the range explained as preferable in the lens design shown in FIG. 13 and/or the lens A having the characteristics shown in FIG. 14 will be described.

### Example 1

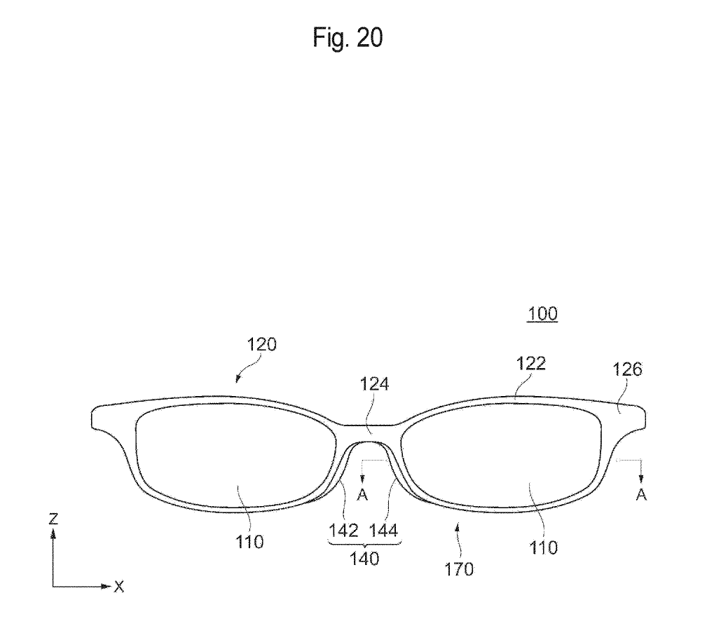

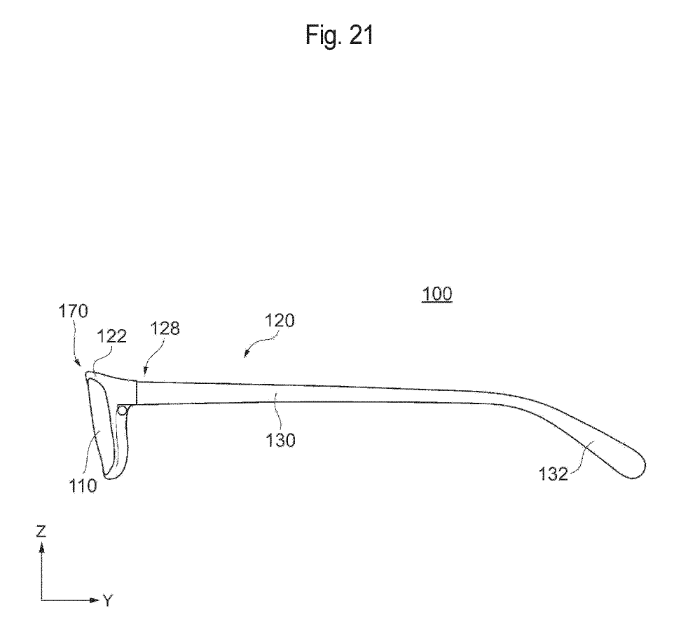

A structure of entire eyeglasses will be described with use of FIGS. 20 and 21. FIG. 20 is a front view showing an example of eyeglasses 100 in example 1. FIG. 21 is a side view showing an example of the eyeglasses 100 in example 1.

The eyeglasses 100 illustrated in FIGS. 20 and 21 is an example of an eyewear, and comprise lenses 110 and a frame 120. The frame 120 has, for example, temples 130, tips 132, and a front 170.

The front 170 supports a pair of lenses 110. Further, the front 170 has, for example, rims 122, a glabella section (a bridge, for example) 124, end pieces 126, hinges 128, and a pair of nose pads 140. The pair of lenses 110 are lenses for assisting accommodation.

Depending on the type of eyeglasses 100, there may be no bridge section of the frame by using only one lens. In this case, a glabella section of the one lens is used as the glabella section.

The pair of nose pads 140 comprises a right nose pad 142 and a left nose pad 144. A pair of rims 122, end pieces 126, hinges 128, temples 130 and tips 132 are provided respectively on a left and right sides. The hinge 128 is not limited to a hinge using a screw, but may be a hinge using a spring, for example.

The rim 122 holds the lens 110. The end piece 126 is provided at an outer side of the rim 122, and holds the temple 130 rotatably by the hinge 128. The temples 130 press upper portions of ears of a user, and secure the part. The tips 132 are provided at tip ends of the temples 130. The tips 132 contact the upper portions of the ears of the user. The tips 132 are not necessarily the components indispensable to the eyeglasses 100.

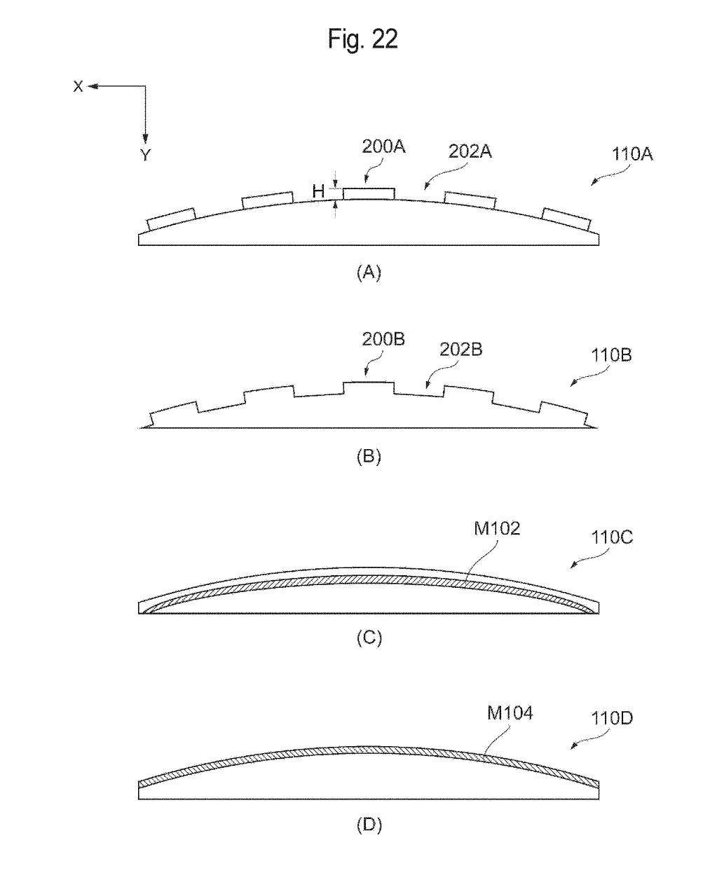

FIG. 22 is a view showing an example of an end surface along line A-A of the lens 110 at the time of wearing the eyeglasses in example 1. Convex portions illustrated in FIG. 22 are not in actual dimensions but illustrated by being enlarged in order to be understandable. The actual convex portions are of sizes at a level of micrometer, for example, and an infinite number of convex portions are present to the lens.

FIG. 22 (A) is a view showing an example of a lens 110A for assisting accommodation. The lens 110A illustrated in FIG. 22 (A) comprises a pattern structure having a plurality of convex portions 200A in a lens main body as a mechanism that reduces contrast. The example of the pattern structure is either the above pattern structure or the pattern structure having the preferable parameters shown in FIG. 13. By the pattern structure, the phase difference is provided in the transmitted light (the reference wavelength, for example), and contrast is reduced. By the convex portions 200A, concave portions 202A are generated among the convex portions 200A. As described above, the convex portion 200A is actually at a level of micrometer, and an infinite number of convex portions 200A are present in the lens main body. A shape of the convex portion 200A is not particularly limited.

The convex portion 200A can be formed by being vapor-deposited on the lens main body. As for a vapor deposition method, a known technique can be used. A material of the convex portion 200A is more preferable as the material has higher transparency and a higher refractive index, and may be an inorganic compound such as a titanium oxide, a zirconium oxide, an aluminum oxide, a silicon nitride, a silicon oxide, a gallium nitride, and a gallium oxide, or an organic compound such as a polycarbonate, an acrylic resin, an urethane resin, an aryl resin, and an epithio resin.

The phase difference is determined by the material of the convex portion 200A and a thickness H, and, for example, after the material is determined, the thickness H can be determined so that a desired phase difference is achieved.

FIG. 22 (B) is a view showing an example of a lens 110B for assisting accommodation. The lens 110B illustrated in FIG. 22 (B) comprises a pattern structure having a plurality of convex portions 200B in a lens main body as a mechanism that reduces contrast. By the pattern structure, the phase difference is provided in the transmitted light, and contrast is reduced. By the convex portions 200B, concave portions 202B are generated among the convex portions 200B, as in FIG. 22 (A). The convex portion 200B is actually of a micrometer level, and an infinite number of convex portions 200B are present in the lens main body. A shape of the convex portion 200B is not particularly limited.

In the case of the lens 110B illustrated in FIG. 22 (B), the lens main body and the convex portion 200B are of a same material. Therefore, cost reduction and volume production are enabled by forming the convex portions 200B by using a machining technique, rather than adding the convex portions 200A by vapor deposition or the like as illustrated in FIG. 22 (A).

FIG. 22 (C) is a view showing an example of a lens 110C for assisting accommodation. In the lens 110C illustrated in FIG. 22 (C), as a mechanism that reduces contrast, a film thickness layer M102 having the pattern structure illustrated in FIG. 22 (A) or (B) is provided inside the lens main body. Thereby, the film thickness layer M102 is contained in the lens main body, so that deterioration of the film thickness layer M102 can be prevented, and an effect of assisting accommodation can be kept permanently.

FIG. 22 (D) is a view showing an example of a lens 110D for assisting accommodation. In the lens 110D illustrated in FIG. 22 (D), as a mechanism that reduces contrast, a sheet M104 having the pattern structure illustrated in FIG. 22 (A) or (B) is provided inside the lens main body. Consequently, by attaching the sheet M104 to a surface of the lens main body, the effect of assisting accommodation can be easily added to the conventional lens.

The lenses illustrated in FIG. 22 described above each comprise the mechanism that causes the light incident on the lens main body to generate the first phase and the second phase, and reduces contrast by the phase difference between the first phase and the second phase. Further, in the lenses illustrated in FIG. 22, a difference in light transmittance may be provided in the convex portions 200 and the concave portions 202, or in the pattern portion and the non-pattern portion. Thereby, near vision can be improved while focus is easily obtained.

In each of the lenses illustrated in FIGS. 22 (A) and (B), the pattern structure may be provided on an outer surface (minus Y direction), an inner surface (Y direction) or both the surfaces of the lens. Further, the lens main bodies or the pattern structures may be transparent or colored. Further, a hard coat layer that prevents a scar and an anti-reflection coated layer may be stacked on the lens surfaces.

### Example 2

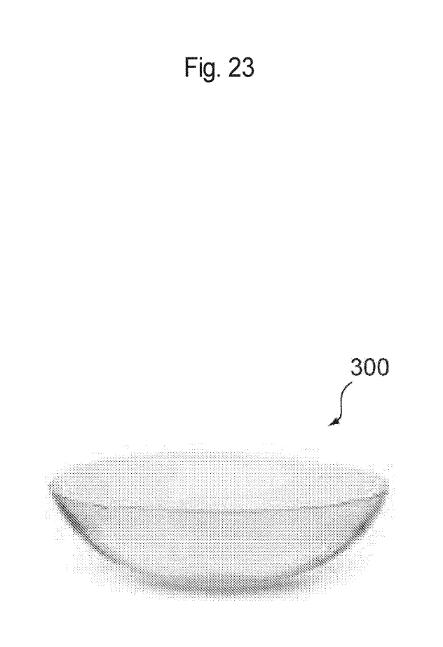

In example 2, the case of applying the function of the aforementioned lens to a contact lens will be described. FIG. 23 is a view showing an example of the contact lens in the second example. A contact lens 300 shown in FIG. 23 has the mechanism that reduces contrast and the mechanism that provides a difference in light transmittance between the pattern portion and the non-pattern portion, which are described above. For example, the contact lens 300 has a pattern providing a phase difference to the reference wavelength, and is provided with the sheet having a difference in transmittance between the pattern portion and the non-pattern portion, on a surface or an inside of the contact lens. Thereby, the aforementioned effects can be exhibited.

### Example 3

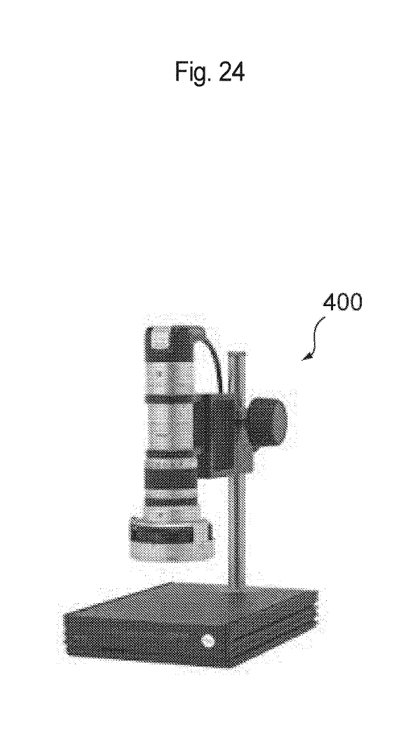

In example 3, the case of applying the functions of the lens described above to a scope optical system will be described. FIG. 24 is a view showing an example of the scope optical system in the third example. A scope optical system 400 shown in FIG. 24 is a lens of a microscope or the like, and has the mechanism that reduces contrast described above, and the mechanism that provides a difference in light transmittance between the pattern portion and the non-pattern portion. For example, the scope optical system 400 has a pattern providing a phase difference to the reference wavelength, and is provided with the sheet having a difference in transmittance between the pattern portion and the non-pattern portion, on a surface or an inside of the contact lens. Thereby, the aforementioned effects can be exhibited.

### Modified Examples

Besides the lenses illustrated in FIG. 22, the present invention may use a lens that reduces contrast by changing the light-shielding rate.

Further, the lenses in the present invention may be applied to a progressive power (presbyopia) lens and the like. Thereby, the user wearing the progressive power lens can easily focus when the user moves focus. Further, the user can easily obtain focus, and therefore can read a book easily in a shaking place.

Further, the lens in the present invention may be applied to sunglasses for sports or the like. This makes it easier for the user wearing the sunglasses to follow the movement of a ball during ball game.

Further, the lens in the present invention may be also applied to a lens for a camera and the like, besides the lens for eyeglasses. Further, the dots are not limited to those in a round shape but may include those in a polygonal shape.

Further, a lens may be used, which reduces contrast by generating a phase difference by changing a refraction index of light by inserting a plurality of microscopic glass beads in predetermined positions of an inside of a lens main body so that visibility is not impaired.

Further, a lens may be used, which reduces contrast by generating a phase difference by changing a refraction index of light in a predetermined position or partially changing a light-shielding rate, by partially changing optical characteristics, with respect to a lens main body using a material the optical characteristics of which change.

The present invention is described by using the examples and the modified examples thus far, the technical range of the present invention is not limited to the ranges of the descriptions of the above described examples and modified examples. It is obvious to a person skilled in the art that various changes or alterations can be added to the above described examples and modified examples. It is obvious from the statements in the Claims that modes to which such modifications or alterations are added can be also included in the technical range of the present invention.

### REFERENCE SIGNS LIST

100 Eyeglasses
110 Lens
300 Contact lens
400 Scope optical system

1. An accommodation assisting lens, comprising:
a lens main body; and
dots that are isotropically and uniformly disposed in the lens main body,
wherein in a visible light region, a difference in average transmittance between a dot portion based on the dots, and a non-dot portion other than the dot portion is 2% to 50% inclusive,
wherein a pattern forming the non-dot portion is a coloring matter pattern composed of a metal, and
wherein the difference in the average transmittance is produced by the coloring matter pattern.

2. The accommodation assisting lens according to claim 1,
wherein a difference in average transmittance between the dot portion and the non-dot portion in a predetermined region in the visible light region is larger than a difference in average transmittance between the dot portion and the non-dot portion in a region other than the predetermined region other than the visible light region.

3. The accommodation assisting lens according to claim 2,
wherein the predetermined region includes at least a blue wavelength region.

4. The accommodation assisting lens according to claim 1,
wherein the dot portion and the non-dot portion have an optical phase difference φ.

5. The accommodation assisting lens according to claim 4,
wherein the phase difference φ satisfies 0<Φ≦π/4, with respect to a wavelength of 546 nm.

6. The accommodation assisting lens according to claim 5,
wherein the phase difference φ satisfies π/5<φ≦π/4, with respect to the wavelength of 546 nm.

7-8. (canceled)

9. The accommodation assisting lens according to claim 1, further comprising an anti-reflection film pattern,
wherein the difference in the average transmittance is formed by using the anti-reflection film pattern and the coloring matter pattern.

10. The accommodation assisting lens according to claim 4,
wherein the phase difference is formed by cutting a surface of the lens main body, or formed with the lens main body by using a die or a nanoimprinting technique.

11. The accommodation assisting lens according to claim 4, further comprising:
a mechanism that produces the phase difference or the difference in the average transmittance,
wherein the mechanism is formed of a film, and the film is provided on a surface of the lens main body or an inside of the lens main body.

12. An eyewear, comprising:
the accommodation assisting lens according to claim 1; and
a frame supporting the accommodation assisting lens.

13. A contact lens that is the accommodation assisting lens according to claim 1.

14. A scope optical system comprising the accommodation assisting lens according to claim 1.

15. The accommodation assisting lens according to claim 1, wherein the metal is not oxidized in the coloring matter pattern composed of the metal.

16. The accommodation assisting lens according to claim 1, further comprising a hard coat layer.

17. The accommodation assisting lens according to claim 9,
wherein a silicon dioxide and a zirconium dioxide are alternately stacked in the anti-reflection film pattern.
